(19) United States
(12) Patent Application Publication
(10) Pub. No.: US 2009/0209137 A1
(43) Pub. Date: Aug. 20, 2009

(54) POWER SOCKET AND METAL PIN THEREOF AND MANUFACTURING METHOD OF THE METAL PIN

(76) Inventors: Hung-Tsu HSU, Taoyuan City (TW); Ta-Chuan Wei, Taoyuan City (TW)

Correspondence Address: Guice Patents PLLC, 12647 Galveston Court #302, Manassas, VA, 20112, US

(21) Appl. No.: 12/180,591

(22) Filed: Jul. 28, 2008

(30) Foreign Application Priority Data
Feb. 14, 2008 (TW) 097105175

(51) Int. Cl. H01R 13/02; H01R 24/04; H01R 43/16

(52) U.S. Cl. 439/668; 439/884; 29/874

(57) ABSTRACT

The present invention relates to a power socket, comprises: at least two metal pins respectively and integratedly formed by punching and bending a solid round-column shaped metal wire, so one end of each of the metal pins is defined as a solid round-column shaped contact section, and the other end of each of the metal pins is defined as a flat terminal section, and the top end of each of the contact sections is provided with an arc-shaped head section; and an insulating seat member which is a solid member formed via an operation of plastic injecting formation, the insulating seat member is served to cover and retained the at least two metal pins, so a connecting hole is formed on one surface of the seat member for accommodating and positioning the at least two round-column shaped contact sections, the other surface of the seat member is served to let the at least two flat terminal sections expose outside. The present invention further provides a metal pin used in a power socket and manufacturing method of the metal pin.

### BACKGROUND OF THE INVENTION

1. Field of the Invention

The present invention relates to a power socket, more particularly to a power socket wherein one end of a solid metal pin is defined as a round-column shaped contact section and the other end thereof is defined as a flat terminal section, and the metal pin is integratedly made by punching and bending and is operated with an embedded-type plastic injecting formation so as to form a power socket. The present invention further provides a metal pin used in a power socket and manufacturing method of the metal pin.

2. Description of Related Art

Power sockets are commonly used in electronic goods, e.g. a portable audio player or a DVD player, or in information products such as a computer, a power wire whose two ends are both sockets is used and the two ends are respectively plugged into a power socket of a product and a socket of public electricity, so the power is provided to the product and a user can therefore operate the product.

The must have units in an assembly of a power socket is at least two metal pins, conventional metal pins can be categorized to two sorts, hollow and solid; a hollow metal pin is made by punching a metal sheet, e.g. a copper sheet, for obtaining a sheet member having a pre-determined shape, then one end of the sheet member is rolled so as to be defined as a round-column shaped contact section, the other end thereof is integratedly extended so as to be defined as a flat terminal section, the advantages thereof is that the contact section and the terminal section are made as one piece, instead of being connected via rivets. The disadvantage of the hollow metal pin is that the hollow metal pin is made via a rolling formation, so the strength of the hollow metal pin is not strong enough and is easily to be deformed. Regarding to the disadvantages mentioned above, the applicant of the present invention has disclosed a solution, such as Taiwan Patent No. M292812, titled “Power supply connector”, the above mentioned patent disclosed that, in a power socket, an insulating column (a jointing section) of a seat member is received in accommodating spaces respectively formed inside each contact section of each hollow metal pin, so the strength of the pins and the structural stress are increased. With the raising costs of the metal sheets, the formation of the hollow metal pins result in an issue of wasting materials, and the manufacturing cost is therefore increased. In fact, serious disadvantages of both of a hollow metal pin and a hollow metal pin provided in an insulating column are that the thickness is not enough so the voltage endurance and the current endurance are obviously not enough and can not pass the safety regulation.

For overcoming the above mentioned disadvantages of a hollow metal pin, skilled people in the art has disclosed a power socket having a solid metal pin, as shown in FIG. 1, a seat member 10 of the power socket is provided with a solid contact pin 20 and a terminal 30, the solid contact pin 20 and the terminal 30 are riveted and embedded in the insulating seat member 10, such connecting means has to consider the riveting strength. Beside, for manufacturing the solid contact pin, operation procedures of cutting and riveting are increased and result in a higher production cost; for preventing the solid contact pin 20 from loosing, a blocking ring 201 having a larger outer diameter is radially provided to the solid contact pin 20, and the outer diameter of the blocking ring 201 is the original outer diameter of the solid metal round-column shaped member; the solid contact pin 20 and the blocking ring 201 are made via cutting the original solid metal round-column shaped member, and the amount of the cut-off material is about 40% thus the production cost is hard to be reduced. More over, if the riveting strength between the solid contact pin 20 and the terminal 30 is not strong enough, or when an external force is strong enough to cause a loosing effect on the riveting position between the solid contact pin 20 and the terminal 30, sparks or loose may be generated due to the high temperature or the poor combination, and this will greatly effect the safe operation and shall be improved.

### SUMMARY OF THE INVENTION

The applicant of the present invention has devoted himself to design and commercially distribute electric switches and with a hope to overcome disadvantages of riveting hollow metal pins and solid metal pin and terminals, after try and error, the present invention “Power socket and metal pin thereof and manufacturing method of the metal pin” is provided.

One object of the present invention is to provide a solution in which a metal pin is made by punching and bending a solid round-column shaped metal wire, so one end of the metal pin is defined as a round-column shaped contact section and the other end is defined as a flat terminal section, so both advantages of a hollow metal pin and a solid metal pin are obtained and the object that the metal pin is integratedly formed as one piece is also achieved. At least two integratedly-formed metal pins are provided in a mold, then an operation of embedded-type plastic injecting formation is processed so a power socket is obtained. Because the contact section of the metal pin provided by the present invention is a solid round-column shaped member, lacks of strength, voltage endurance and current endurance are avoided; the terminal section of the metal pin provided by the present invention is integratedly and extendedly formed as one piece with the contact section, instead of being connected via riveting, so concerns of loosing or being damaged by an external force are avoided, thus the safety of using the power socket provided by the present invention can be ensured. The manufacturing method of the metal pin has advantages of saving working-time, manufacturing-procedures and materials, so the production cost is lowered and the service life of the power socket is prolonged.

For achieving the object mentioned above, one solution provided by the present invention is to provide a power socket, comprises: at least two metal pins respectively and integratedly formed by punching and bending a solid round-column shaped metal wire, so one end of each of the metal pins is defined as a solid round-column shaped contact section, and the other end of each of the metal pins is defined as a flat terminal section, and the top end of each of the contact sections is provided with an arc-shaped head section; and an insulating seat member which is a solid member formed via an operation of plastic injecting formation, the insulating seat member is served to cover and retained the at least two metal pins, so a connecting hole is formed on one surface of the seat member for accommodating and positioning the at least two round-column shaped contact sections, the other surface of the seat member is served to let the at least two flat terminal sections expose outside.

Another solution provided by the present invention is to provide a metal pin used in a power socket, the metal pin is integratedly formed by punching and bending a solid round-column shaped metal wire, so one end of the metal pin is defined as a solid round-column shaped contact section, and the other end of the metal pin is defined as a flat terminal section, and the top end of the contact section is provided with an arc-shaped head section.

One another solution provided by the present invention is to provide a manufacturing method of a metal pin used in a power socket, the manufacturing method comprises the steps of: a feeding step, a solid round-column shaped metal wire is provided on a feeding machine and one end of the metal wire is introduced into an automatic punching formation mold; a step of positioning and forming a contact section, the mental wire is operated to pass through material-guiding seats provided at the front end of the mold, so the metal wire is positioned between the two material-guiding seats then the mental wire is laterally punched by two punching blocks provided at the lateral side with respect to the metal wire, so the front and the rear ends of the metal wire are respectively provided with a cutting mark with respect to the length of the metal pin, and a flat and straight contact section is defined on the metal wire; a step of trimming a head section of the contact section, the metal wire whose length is determined is forwardly moved, and the cutting mark of the rear end of the metal wire is punched by a head-section punching block so an arc-shaped head section is obtained; a step of forming a terminal section, the front end of the metal wire is punched by a terminal-section punching block so a flat terminal section is obtained, the terminal section is formed as one piece with the contact section and is laterally extended from the solid round-column shaped contact section; and a cutting step, the semi-finished product having the contact section and the terminal section is conveyed to the rear end of the mold, when the terminal section is in contact with a position-limiting block, the head section of the contact section is cut off by a cutting punching block, so the contact section is separated from another terminal section of another metal pin, the finished product of the metal pin having the arc-shaped head section is obtained.

### BRIEF DESCRIPTION OF THE DRAWINGS

FIG. 1 is a cross sectional view of a conventional power socket;

FIG. 2 is a 3D view of the metal pin used in the power socket provided by the present invention;

FIG. 3 is a cross sectional view of the power socket having the metal pin shown in FIG. 2;

FIG. 4 is a 3D view of the power socket shown in FIG. 3;

FIG. 5 is a 3D view of a metal pin of another embodiment of the present invention;

FIG. 6 is a cross sectional view of the power socket having the metal pin shown in FIG. 5;

FIG. 7 is a 3D view of a metal pin of another embodiment of the present invention;

FIG. 8 is a cross sectional view of the power socket having the metal pin shown in FIG. 7;

FIG. 9 is a flow chart of the manufacturing method of the metal pin provided by the present invention.

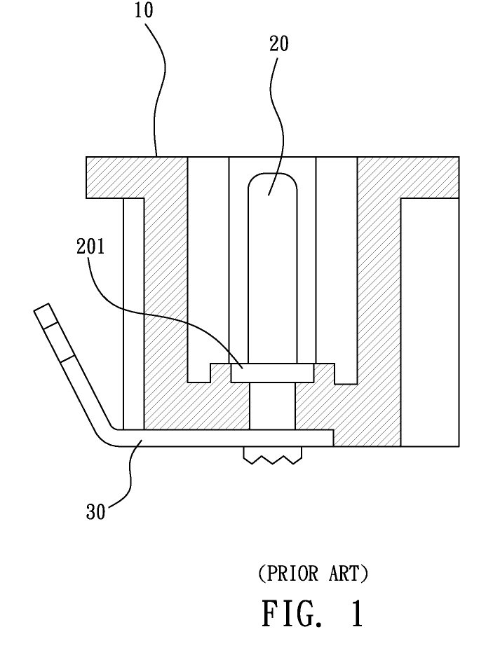

### DETAILED DESCRIPTION OF THE PREFERRED EMBODIMENT

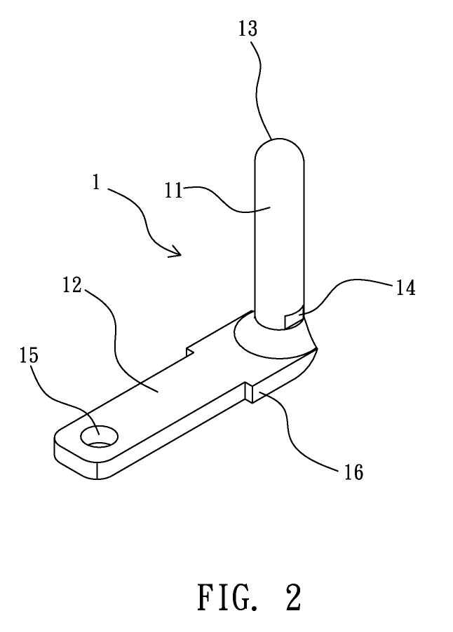

As shown from FIG. 2 to FIG. 4, the power socket provided by the present invention is composed by at least two metal pins 1 and an insulating seat member 2.

Each of the metal pins 1 is integratedly formed by punching and bending a solid round-column shaped metal wire, so one end of each of the metal pins 1 is defined as a solid round-column shaped contact section 11, the other end thereof is defined as a flat terminal section 12. Each of the contact sections 11 and each of the terminal sections 12 are both punched and bended therefore an included angle, e.g. a 90-degree included angle, is formed between each of the contact sections 11 and the corresponding terminal section 12, so the metal pin 1 is shaped to an L-shape as shown in FIG. 2. For providing a better connecting relationship between the power socket and the contact section 11, the top end of the contact section 11 is provided with an arc-shaped head section 13, and for having a better connecting relationship between the contact section 11 and the seat member 2, at least one concave section 14 is provided at the bottom end of the contact section 11, so when an accommodating section 15 is formed on the terminal section 12 and when the terminal section 12 is bended, the concave section 14 can be served to retain the contact section 11 for preventing the contact section 11 from rotating.

The terminal section 12 has at least one accommodating section 15, e.g. a through hole or a concave slot, for being operated with a welding operation. For providing a better connecting relationship between the terminal section 12 and the seat member 2, a flange 16 is respectively extended from two lateral sides of the terminal section 12, so when the terminal section 12 is covered by plastic materials, the solidified plastic materials can be served as blocks for blocking the pair of flanges 16, so the metal pin 1 can be stably retained in the seat member 2.

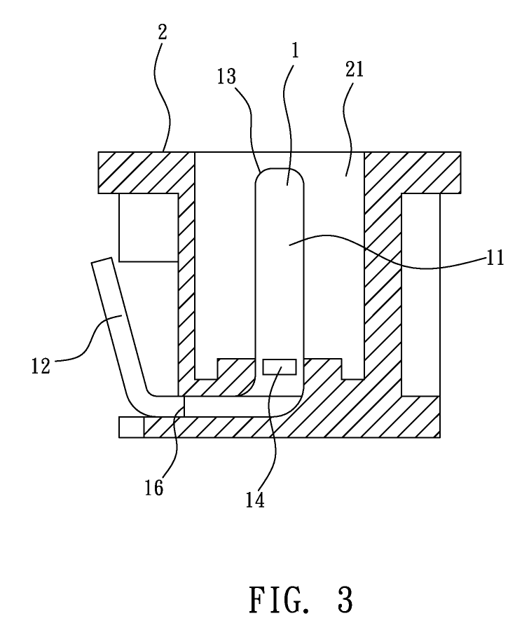

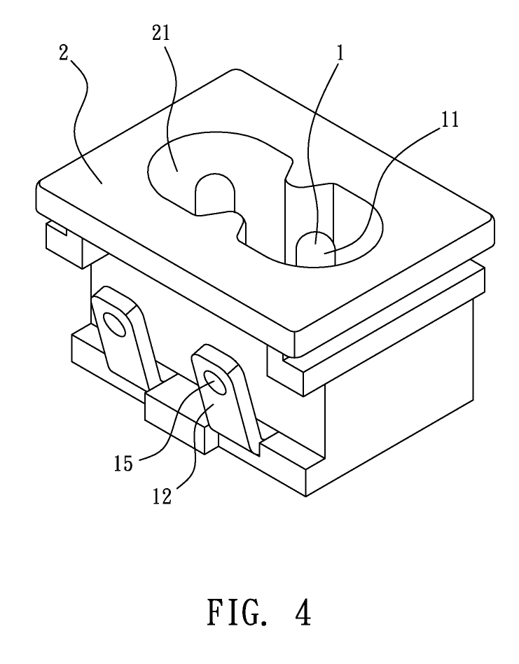

The seat member 2 is a solid member made via a plastic injecting formation, to manufacture a power socket, at least two metal pins 1 are stably provided in a mold for forming the seat member 2, high-temperature liquid plastic materials are poured into the mold via an embedded-type plastic injecting formation, so when the seat member 2 is formed, the certain portions of the metal pins 1, e.g. the lower portions of the contact sections 11 and the front portions of the terminal sections 12, are also positioned and retained, so each of the contact sections 11 is accommodated and positioned in a connecting hole 21 provided on a surface of the seat member 2, and the rear portions of the two terminal sections 12 are exposed outside of the other surface of the seat member 2, then the power socket provided by the present invention is manufactured. The terminal sections 12 can be operated with a punching operation according to actual needs, so the terminal sections 12 respectively have a bending angle, as shown in FIG. 3 and FIG. 4.

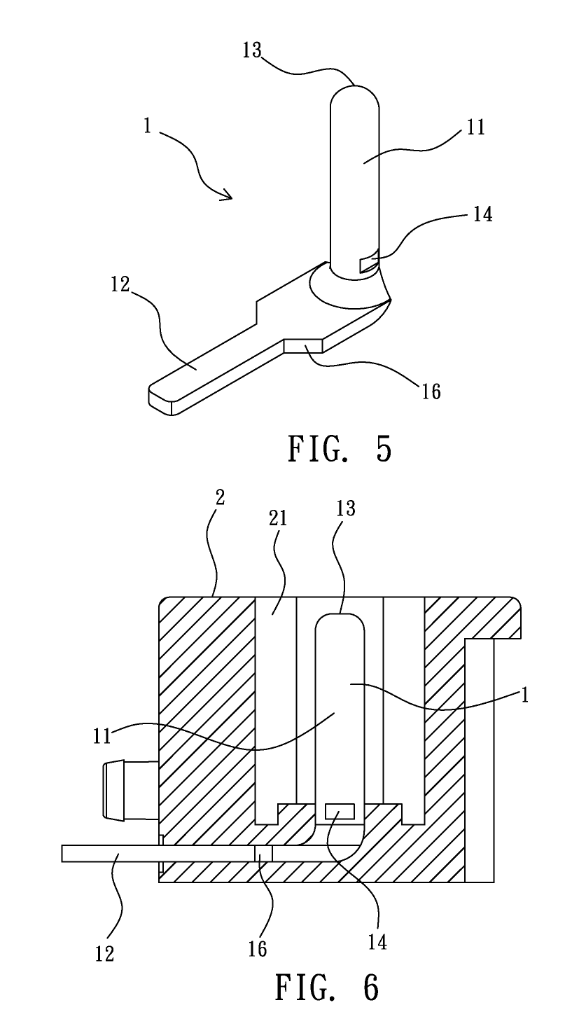

As shown in FIG. 5, which is another embodiment of the present invention, the difference between this embodiment and the previous embodiment is that there is no accommodating section provided and the width of the terminal section 12 is narrower. Referring to FIG. 6, what is shown is that after the metal pin 1 shown in FIG. 5 is being operated with an injecting formation with the insulating seat member 2, the terminal section 12 is straightly and transversally extended from the lateral wall of the seat member 2, and no bending operation is processed, so the terminal section 12 can be directly mounted on a printed circuit board.

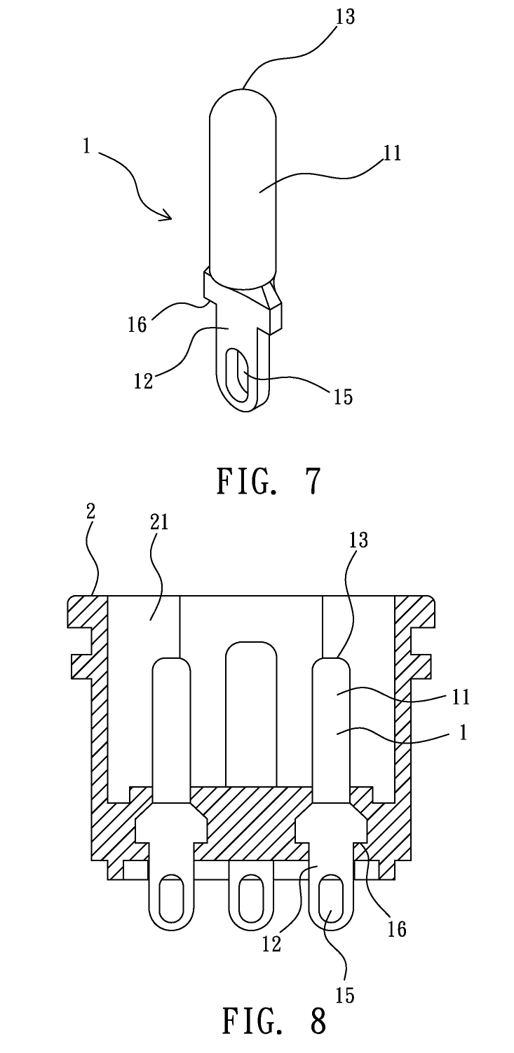

As shown in FIG. 7, which is another embodiment of the metal pin 1 provided by the present invention, the difference between this embodiment and the previous two embodiments is the contact section 11 and the terminal section 12 are straightly provided and there is no included angle generated. Referring to FIG. 8, what is shown is that after the metal pin 1 shown in FIG. 7 is being operated with an injecting formation with the insulating seat member 2, the terminal section 12 is straightly and longitudinally extended from the bottom end of the seat member 2.

The metal pin of the power socket provided by the present invention is formed by punching and bending a solid round-column shaped metal wire, e.g. a copper wire, so one end of the metal wire is defined as a solid round-column-shaped contact section 11 having advantages of good strength, voltage endurance and current endurance and is qualified to pass the safety regulation; the other end is defined as a terminal section 12 which is integratedly extended and bended from the contact section 11, instead of being jointed via riveting, so the loose or the release resulted from the poor riveting is prevented, the safety use is therefore ensured, and the service life of the power socket is prolonged.

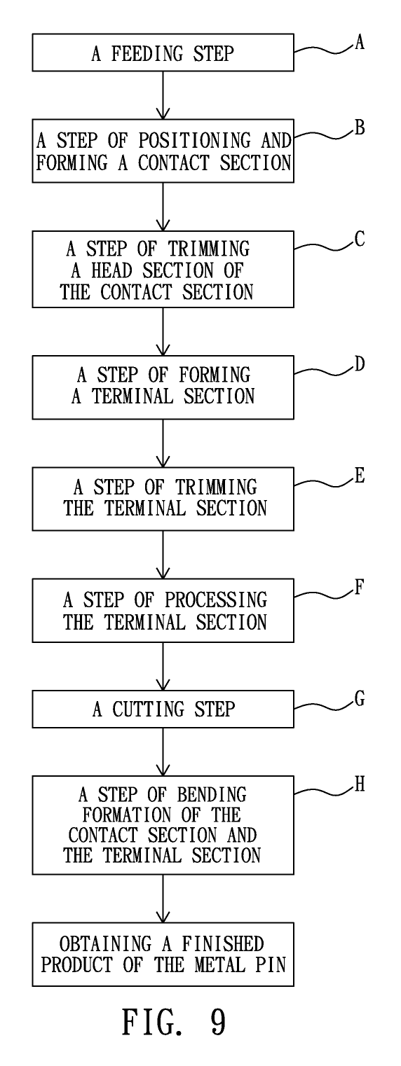

Referring to FIG. 9, what is disclosed is the flow chart of the manufacturing method of the metal pin provided by the present invention, the manufacturing method comprises the steps of: a feeding step (A), a step of positioning and forming a contact section (B), a step of trimming a head section of the contact section (C), a step of forming a terminal section (D), a step of trimming the terminal section (E), a step of processing the terminal section (F), a cutting step (G), and a step of bending formation of the contact section and the terminal section (H).

In the feeding step (A), a solid round-column shaped metal wire, e.g. a copper wire, is provided on a feeding machine and one end of the metal wire is introduced into an automatic punching formation mold.

In the step of positioning and forming a contact section (B), material-guiding seats are provided at the front end of the automatic punching formation mold for introducing the solid round-column shaped metal wire into the mold, then the metal wire is positioned between the two material-guiding seats then the metal wire is laterally punched by two punching blocks provided at the lateral side with respect to the metal wire, so the front and the rear ends of the metal wire are respectively provided with an arc-shaped cutting mark with respect to the length of the metal pin, and a flat and straight contact section is defined on the metal wire.

In the step of trimming a head section of the contact section (C), the metal wire whose length is determined is forwardly moved, and the cutting mark of the rear end of the metal wire is punched by a head-section punching block provided above the metal wire so an arc-shaped head section is obtained. The step (C) is that when precisely processing the arc-shaped head section of the round-column shaped contact section, and the metal wire is not separated from adjacent metal wires and still in a connecting status.

In the step of forming a terminal section (D), the front end of the solid metal wire is punched by a terminal-section punching block so a flat terminal section is obtained, the terminal section is laterally extended from the solid round-column shaped contact section, in other words the contact section and the terminal section are formed as one piece, instead of connecting via riveting.

In the step of trimming the terminal section (E), a front end of a semi-finished product having the contact section and the terminal section is moved to a flange-punching block, after being punched, part of the two lateral ends of the terminal section is cut off so a flange is respectively formed at the two lateral ends of the terminal section, for enhancing the connecting effect with the insulating seat member.

In the step of processing the terminal section (F), the terminal section whose two lateral ends are trimmed is moved to a processing punching block, and after being punched, the terminal section is provided with an accommodating section such like a through hole or a concave slot, so when an welding operating is processed, the welding material can be accommodated, thus the connecting strength between the terminal section and the object to be welded, e.g. a printed circuit board, is increased.

In the cutting step (G), the semi-finished product having the contact section and the terminal section is conveyed to the rear end of the automatic punching formation mold, when the terminal section is in contact with a position-limiting block, the head section of the contact section is cut off by a cutting punching block, so the contact section is separated from a terminal section of another metal pin provided behind, a metal pin having an arc-shaped head section and no included angle between the contact section and the terminal section is obtained, as shown in FIG. 7.

In the step of bending formation of the contact section and the terminal section (H), the terminal section of the metal pin obtained in the cutting step G is bended by a bending punching block, so an included angle is formed between the contact section and the terminal section, the finished product of the L-shaped metal pin is obtained, as shown in FIG. 2 and FIG. 5.

In the manufacturing method mentioned above, a solid round-column shaped metal wire is processed with steps of multi-punching for forming, trimming, cutting and bending, one end of the integratedly-formed metal pin is defined as a solid round-column shaped contact section, and the other end thereof is defined as a flat terminal section, and an anticipated structural strength is also achieved, and the terminal section and the contact section are integratedly formed as one piece, instead of being connected via riveting which may loose and cause dangers, therefore the safety use is ensured and the service life of the power socket is prolonged. Comparing to a metal pin made by conventional means of cutting and riveting, the metal pin manufactured by the manufacturing method provided by the present invention has advantages of saving materials, fast in formation, and the automatic punching formation mold adopted by the present invention can increased the production rate up to 20 times.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A power socket, comprises:
at least two metal pins respectively and integratedly formed by punching and bending a solid round-column shaped metal wire, so one end of each of the metal pins is defined as a solid round-column shaped contact section, and the other end of each of the metal pins is defined as a flat terminal section, and the top end of each of the contact sections is provided with an arc-shaped head section; and
an insulating seat member, which is a solid member formed via an operation of plastic injecting formation, the insulating seat member is served to cover and retained the at least two metal pins, so a connecting hole is formed on one surface of the seat member for accommodating and positioning the at least two round-column shaped contact sections, the other surface of the seat member is served to let the at least two flat terminal sections expose outside.

2. The power socket as claimed in claim 1, wherein an included angle is generated between the contact section and the terminal section of the metal pin.

3. The power socket as claimed in claim 1, wherein at least one concave section is provided at the bottom end of the contact section.

4. The power socket as claimed in claim 1, wherein the terminal section is provided with an accommodating section, which is a through hole or a concave slot.

5. The power socket as claimed in claim 1, wherein a flange is respectively extended from the two lateral sides of the terminal section.

6. The power socket as claimed in claim 1, wherein the at least two terminal sections exposed outside the seat member can be bended with angles according to actual needs.

7. A metal pin used in a power socket, the metal pin is integratedly formed by punching and bending a solid round-column shaped metal wire, so one end of the metal pin is defined as a solid round-column shaped contact section, and the other end of the metal pin is defined as a flat terminal section, and the top end of the contact section is provided with an arc-shaped head section.

8. The metal pin of the power pocket as claimed in claim 7, wherein an included angle is generated between the contact section and the terminal section of the metal pin.

9. The metal pin of the power pocket as claimed in claim 7, wherein at least one concave section is provided at the bottom end of the contact section.

10. The metal pin of the power pocket as claimed in claim 7, wherein the terminal section is provided with an accommodating section, which is a through hole or a concave slot.

11. The metal pin of the power pocket as claimed in claim 7, wherein a flange is respectively extended from the two lateral sides of the terminal section.

12. A manufacturing method of a metal pin used in a power socket, the manufacturing method comprises the steps of:
a feeding step, a solid round-column shaped metal wire is provided on a feeding machine and one end of the metal wire is introduced into an automatic punching formation mold;
a step of positioning and forming a contact section, the mental wire is operated to pass through material-guiding seats provided at the front end of the mold, so the metal wire is positioned between the two material-guiding seats then the mental wire is laterally punched by two punching blocks provided at the lateral side with respect to the metal wire, so the front and the rear ends of the metal wire are respectively provided with a cutting mark with respect to the length of the metal pin, and a flat and straight contact section is defined on the metal wire;
a step of trimming a head section of the contact section, the metal wire whose length is determined is forwardly moved, and the cutting mark of the rear end of the metal wire is punched by a head-section punching block so an arc-shaped head section is obtained;
a step of forming a terminal section, the front end of the metal wire is punched by a terminal-section punching block so a flat terminal section is obtained, the terminal section is formed as one piece with the contact section and is laterally extended from the solid round-column shaped contact section; and
a cutting step, the semi-finished product having the contact section and the terminal section is conveyed to the rear end of the mold, when the terminal section is in contact with a position-limiting block, the head section of the contact section is cut off by a cutting punching block, so the contact section is separated from another terminal section of another metal pin provided behind, therefore the finished product of the metal pin having the arc-shaped head section is obtained.

13. The manufacturing method of a metal pin used in a power socket as claimed in claim 12, wherein the manufacturing method further comprises a step of bending formation of the contact section and the terminal section, the terminal section of the metal pin obtained in the cutting step is bended by a bending punching block, so a finished product of a metal pin in which an included angle is formed between the contact section and the terminal section is obtained.

14. The manufacturing method of a metal pin used in a power socket as claimed in claim 12, wherein the manufacturing method further comprises a step of trimming the terminal section that is processed after the step of forming the terminal section, a front end of a semi-finished product having the contact section and the terminal section is moved to a flange-punching block, after being punched, part of the two lateral ends of the terminal section is cut off so a flange is respectively formed at the two lateral ends of the terminal section.

15. The manufacturing method of a metal pin used in a power socket as claimed in claim 14, wherein the manufacturing method further comprises a step of processing the terminal section that is processed after the step of trimming the terminal section, the terminal section whose two lateral ends are trimmed is moved to a processing punching block, and after being punched, the terminal section is provided with an accommodating section, which is a through hole or a concave slot.
